(19) United States
(12) Patent Application Publication
(10) Pub. No.: US 2012/0192495 A1
(43) Pub. Date: Aug. 2, 2012

(54) Access Door for Circular Cross-Section Ductwork

(76) Inventor: Alvin F. Coughenour, JR., Elizabeth, PA (US)

(21) Appl. No.: 13/358,617

(22) Filed: Jan. 26, 2012

Related U.S. Application Data
(60) Provisional application No. 61/437,283, filed on Jan. 28, 2011.

(51) Int. Cl. E06B 5/00; F16B 33/00; E06B 7/16; B23P 11/00; B23P 19/08

(52) U.S. Cl. 49/464; 29/428; 29/525.02; 411/366.1

(57) ABSTRACT

A duct access door for use with ducts of circular cross-sections that carry cooking vapors and greases is a “sandwich” type door that has inner and outer arcuate plates, the inner plate being positioned inside the circular duct and the outer plate outside the duct with a heat resistant gasket attached to the outer plate. Strategically located bolts draw the plates together to compress the gasket and prevent leaking of vapors and greases. Sliding captive nut assemblies accommodate the arcuate shape of the inner and outer plates so that the bolts may be tightened.

### CROSS-REFERENCE TO RELATED APPLICATIONS

This application claims the benefit of U.S. Provisional Application No. 61/437,283, filed on Jan. 28, 2011, the disclosure of which is hereby incorporated by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates generally to the field of access doors providing access to the interior of a duct, and specifically to an access door designed to provide easy access to the interior of grease ducts and other ducts having a circular cross-section serving, for example, commercial and institutional kitchens, allowing the cleaning, servicing, and inspection of the ducts, or any wires, equipment, or other components located within the ductwork.

2. Description of Related Art

Access doors for ductwork are well known in the prior art. Historically, access doors formed from two plates with a gasket between the plates have been known. The access doors are bolted together so that the two plates may be separated in distance and then the inner plate is inserted into the duct through the duct opening. The outer plate and the gasket remain outside the duct and, when the bolts are tightened, the two plates are drawn together to seal the opening in the duct. This generic type of duct access door has become known as a “sandwich” door for obvious reasons.

To enter the sheet metal ductwork, access openings are usually cut in a rectangular shape which permits the inner plate of a “sandwich” access door to be maneuvered through the diagonal of the rectangular opening and to be positioned inside the duct.

As ducts have come to be used in kitchen service to remove vapors and grease from cooking areas, duct access doors have become more sophisticated in order to obtain approval by Underwriters Laboratories for use in an environment where grease and cooking vapors are present since a fire may occur inside the duct under such conditions. Access doors approved by Underwriters Laboratories must completely seal the duct in order to obtain such approval.

One type of access door which has obtained Underwriters' approval is described in U.S. Pat. No. 5,165,189 issued Nov. 24, 1992 to Bernard P. Besal. This access door requires a frame that must be retrofitted into the duct opening in order to receive a cover with a gasket. This retrofitting is time consuming and expensive and requires a multiplicity of fasteners in order to obtain the necessary sealing.

Until the invention described and claimed in U.S. Pat. No. 6,505,441 B1 issued in Jan. 14, 2003 and assigned to the assignee of the present invention, sandwich-type access doors were not able to meet the sealing requirements of the Underwriters Laboratories for use with grease ducts serving commercial and industrial kitchens. The invention of U.S. Pat. No. 6,505,441 B1 has proven to be very successful commercially for ducts having a rectangular cross-section.

In recent years, ducts having a circular cross-section have become more popular and it has become necessary to provide sealable access doors for those ducts. An attempt was made to form the parts of the invention of U.S. Pat. No. 6,505,441 B1 into an arc in order to be used on a round duct. It was determined that the curvature of the arc caused misalignment problems for the corner bolts of that invention. The present invention was developed to solve the bolt misalignment problems induced by the arcuate shape of the door as well as to permit the doors to be bent into arcuate shapes of varying diameters to accommodate various sizes of circular cross-section ducts.

### BRIEF SUMMARY OF THE INVENTION

An access door to allow access to the interior of a circular cross-section duct having a rectangular opening formed in the duct is provided. The access door includes first and second arcuately formed rectangular plates which are larger in both dimensions than the rectangular duct opening. The first rectangular plate has at least two bolts fixed to it that project outwardly from the first rectangular plate and the first rectangular plate also has movable nuts slidably secured to at least four corners of the plate to receive bolts. The second rectangular plate which is generally of the same size as the first plate has holes registering with the bolts fixed to the first plate and with certain positions of the nuts slidably secured to the corners of the first plate. A non-flammable gasket which can withstand temperatures resulting from burning debris located within a duct is fixed to the second plate and positioned between the first and second plates. Nuts are threaded onto the two bolts fixed to the first plate. Bolts extending through the holes in the second plate and threaded into the slidably secured nuts are provided. The nuts and bolts are unthreaded sufficiently to permit the first plate to be inserted into the duct and thereafter the nuts and bolts are tightened to draw the first and second plates together and to exert a compressive force upon the gasket.

The access door of the present invention can be inserted into any circular cross-section duct rectangular opening without modification of the rectangular opening in any way whatsoever. The usual procedure is to provide an access opening template with the access door of the present invention so that the template fixes the size of the rectangular duct opening and provides a rectangular opening which when the access door is positioned within the opening, there is a one inch space where the access door overlaps every side of the rectangular opening.

By strategically positioning additional bolts at the four corners of the access door, and in some cases along the edges of the access door, the access door has been made air tight, vapor tight, and grease tight so that Underwriters Laboratories' approval may be obtained for the access door of the present invention.

Accordingly, it is an object of the present invention to provide an access door for circular cross-section ductwork which remains structurally intact and leak-proof under duct fire conditions.

It is another object of the present invention to provide an access door which provides easy access to the interior of circular cross-section ductwork.

Another object of the present invention is to provide a sandwich-type duct access door for which approval by Underwriters Laboratories may be obtained for use with various circular cross-section ducting systems.

These and other objects of the present invention all become readily apparent as this description proceeds in conjunction with the accompanying drawings.

### BRIEF DESCRIPTION OF THE DRAWINGS

FIG. 1 is an exploded perspective view of the access door of the present invention.

FIG. 2 is a top plan view of the inner arcuate rectangular plate of the present duct access door.

FIG. 3 is an end elevation of the inner rectangular plate of FIG. 2.

FIG. 4 is a top plan view of the outer arcuate rectangular plate of the present duct access door.

FIG. 5 is an end elevation of the outer arcuate rectangular plate of FIG. 4 and the gasket affixed thereto.

FIG. 6 is a perspective view of one of the captive nuts viewed from outside and slidably connected to the inner arcuate rectangular plate.

FIG. 7 is a perspective view of one of the captive nuts viewed from inside and slidably connected to the inner arcuate rectangular plate.

FIG. 8 is a perspective view of a frame for an access door

### DETAILED DESCRIPTION OF THE PREFERRED EMBODIMENT

Referring to the drawings, there is shown a duct access door indicated generally at 10 having a first inner arcuate rectangular plate 12 and a second outer arcuate rectangular plate 14. Gasket 16 which is coextensive with the rectangular plates 12 and 14 is fixed to the outer rectangular plate 14. The rectangular plates 12 and 14 must be rigid and are preferably formed of steel having a thickness of at least 1/32″ to prevent warping of the plates by heat and most preferably 1/16″.

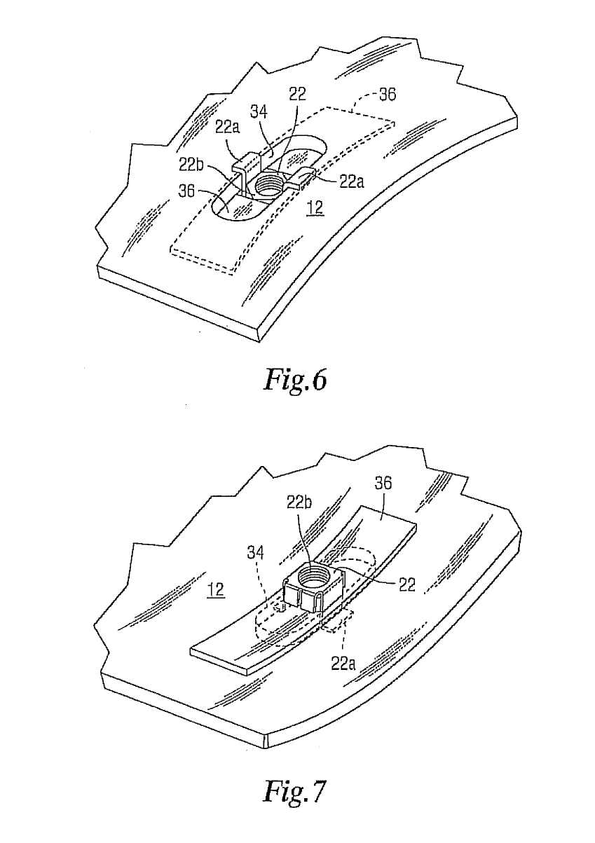

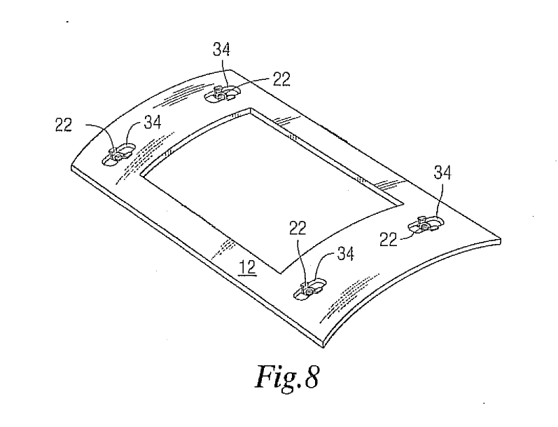

Bolts 18 are fixed to a first plate 12 and project outwardly from the first plate 12. Nuts 20 are provided to be threadingly applied to bolts 18. Captive nuts assemblies 22 are provided at the four corners of first plate 12 and may also be provided along the edges of the plate 12 depending upon the size of the access door 10. These captive nuts assemblies 22 are best shown in FIGS. 6 and 7 and are received in rectangular holes 34 formed in plate 12. Rectangular holes 12 are oriented to be parallel to the ends of arcuate plate 12. It should be noted that in an alternative embodiment of the captive nut assemblies 22 could alternatively be placed in the outer rectangular plate 14.

Formed in the second outer rectangular plate 14 are holes 24 that register with bolts 18 fixed to plate 12. Also formed in outer arcuate plate 14 are holes 26 at the corners of the plate that register with captive nut assemblies 22 on plate 12. Bolts 28 are provided to pass through holes 26 and thread into the captive nut assemblies 22 on arcuate plate 12.

As best seen in FIGS. 6 and 7, the captive nut assembly 22 has supporting wings 22a and a nut 22b secured between the wings 22a. The nut assembly 22 is positioned within a rectangular slot 34 formed in plate 12. The slot 24 is oriented to be parallel with the end of plate 12 and permits the captive nut assembly to slide along slot 34 to positions that readily receive the bolt 28 associated with each nut assembly 22. A sealing plate 36, the position of which is indicated by hidden lines in FIG. 6, is positioned around the nut assembly 22 and next to the concave surface of arcuate wall 12, as shown in FIG. 3. The sealing plate 36 slides with the nut assembly 22 and covers the portions of slot 34 not occupied by nut assembly 22. It should be noted that in an alternative embodiment that the sealing plate 36 can be used in connection with a bolt assembly in which the position of the bolt is adjustable within the slot 34 and a nut would be used in connection with the hole. Typically in this alternative embodiment the holes would be in the first inner rectangular plate 12 and the slots would be in the second outer rectangular plate 14. The adjustable bolt assembly could be the same as the adjustable nut assembly wherein a bolt would extend through the adjustable nut assembly on the second outer rectangular plate 14 and then extending through the hole in the first inner rectangular plate 12 where there would be a corresponding nut which would allow the plates to be compressed together. This embodiment would allow the bolt to slide in the slot in the second outer rectangular plate 14. Additionally, there could be a corresponding sliding nut assembly in both the first rectangular plate 12 and the second outer rectangular plate 14.

During the manufacturing process, the plates 12 and 14 are first formed as flat plates. The plates 12 and 14 are thereafter further formed into their final arcuate shapes. Because of the sliding movement of the nut assemblies 22, the initially flat formed plates 12 and 14 may be formed into shapes with different arcuate radius measurements which permits use with several different sizes of circular cross-section pipe. In addition to being able to form the various radius measurements of the arcuate plates during manufacture, the sliding nut assemblies 22 permit the bolts 28 to align themselves with the nuts 22a which would not be possible with fixed nuts in plate 12, because of the nested nature of the arcuate plates 12 and 14.

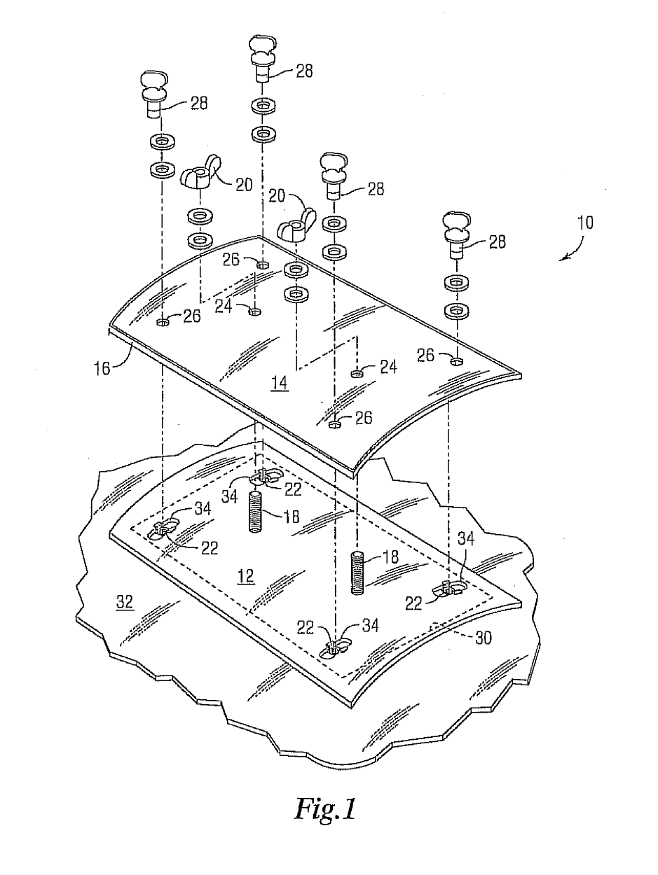

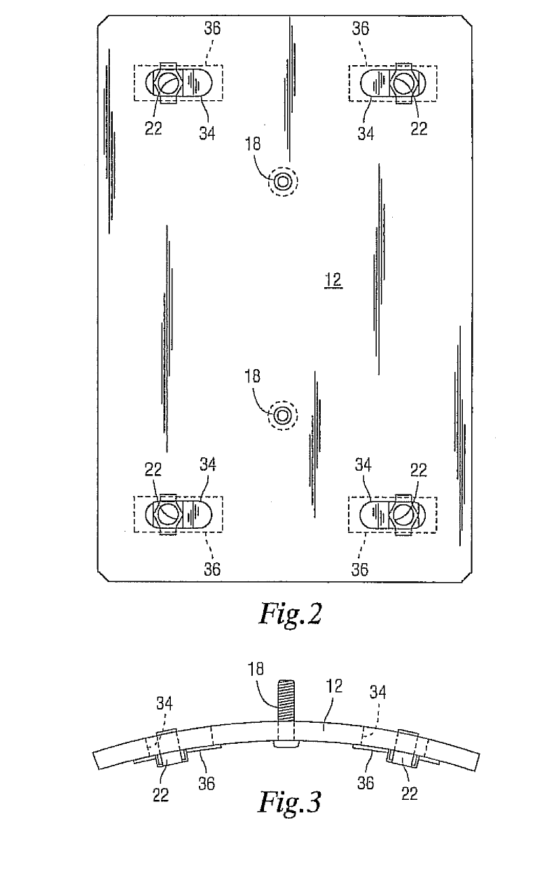

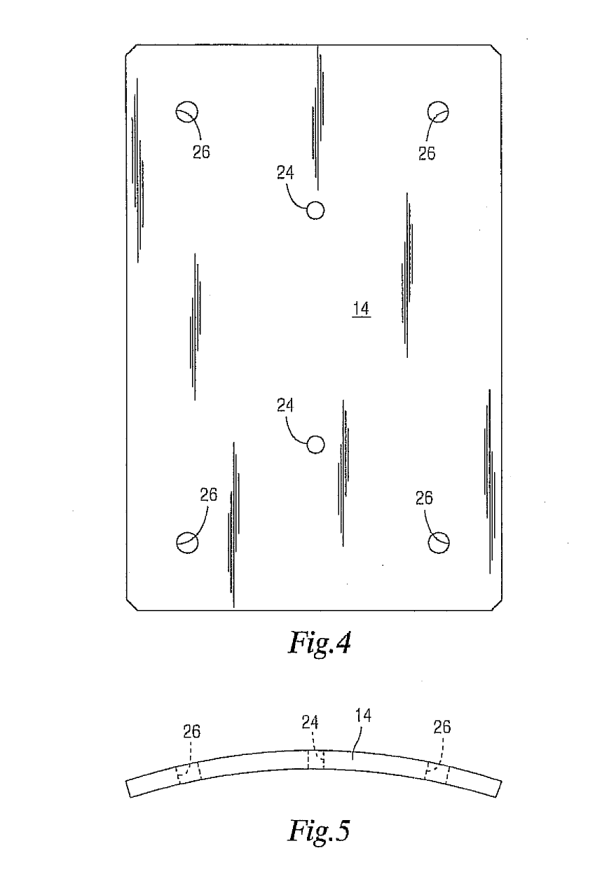

As seen in FIG. 1, an opening 30 in a duct is illustrated in phantom lines. The gasket 16 is attached throughout at least the perimeter of the outer plate 14 and is formed from ceramic fiber board material which is sold commercially by the Unifrax Corporation of Niagara Falls, N.Y. under the trademarks FIBERFRAX® and DURABOARD®. This material is resistant to flame, heat, and grease.

To install access door 10 in a duct, the nuts 20 are loosened on bolts 18 and the bolts 28 are loosened or removed from the corners of the access door. With the outer plate 14 and gasket 16 separated from the plate 12 but still loosely bolted to inner plate 12, the inner plate 12 is maneuvered through the diagonal of the rectangular opening 30 to position inner plate 12 within the duct. The bolts 28 are then inserted through the corners of outer rectangular plate 14 and bolted to inner rectangular plate 12 through nut assemblies 22. The nuts 20 and bolts 28 are then tightened to create a compressive force on gasket 16 and to provide a seal to the access door 10.

### DEFINITIONS

“arced rectangular duct opening member” can be a plate or a frame. As referred to in the above the preferred embodiment it is referred to as a first inner arcuate rectangular plate 12. It can have any shape including rectangular, oval, circular, racetrack (rectangular with curved ends), etc.
“sliding fastener” can be a captive nut assembly or a bolt assembly in which the nut or bolt is able to slide or adjust its position. It can be within the slots.
“a rectangular plate” can be demonstrated as the outer rectangular plate 14. The rectangular plate can have any shape including rectangular, oval, circular, racetrack (rectangular with curved ends), etc.
“rectangular slot” is a slot that has a rectangular shape. The rectangular slot can have square or curved corners.
“a rectangular arced duct opening member complementary sliding captive fastener or hole” can be a hole, a sliding nut assembly, sliding bolt assembly, or an attachment member within the rectangular arced duct opening member that corresponds to a hole, a sliding nut assembly, a sliding bolt assembly, or an attachment member on a rectangular plate.
“a rectangular plate complementary sliding fastener or hole” can be a hole, a sliding nut assembly, sliding bolt assembly, or an attachment member within the rectangular plate that corresponds to a hole, a sliding nut assembly, a sliding bolt assembly, or an attachment member on a rectangular arced duct opening member.
“co-fastener” can be the second part of a fastener. For example a nut could be the co-fastener to a bolt. Alternatively a bolt could be a co-fastener to a nut.
“threadably connects” is connecting using threads
“creating a sealed connection with the circular duct” can be a when the access door is installed in the circular duct a seal is created. The seal may pass the UL tests and prevents smoke and other leakage.
“a second arcuate rectangular plate” can have any shape including rectangular, oval, circular, racetrack (rectangular with curved ends), etc.
“a first arcuate rectangular plate” can have any shape including rectangular, oval, circular, racetrack (rectangular with curved ends), etc.
“a rectangular plate” can have any shape including rectangular, oval, circular, racetrack (rectangular with curved ends), etc.
“corners” toward the edges of the object if the object is round. In a square or rectangular shape it is the standard definition.
“Nut”—the nut can be a square nut or hex nut.

In accordance with the provisions of the patent statutes, I have described the principle, mode of operation and the preferred embodiment of my invention. It should be understood that the invention may be practiced otherwise than as precisely illustrated and described herein in accordance with the claims affixed hereto.

I claim:

1. An access door to allow access to the interior of a circular cross-section duct having an opening formed therein comprising:
(a) a first arcuate rectangular plate larger in each dimension than the duct opening, with the radius of the arc of the plate being approximately the same as the radius of the circular cross-section duct and having an alignment mechanism and having at least four captive nuts slideably retained within rectangular slots at the corners of the plate to receive bolts;
(b) a second arcuate rectangular plate of approximately the same size as the first plate with the radius of the arc of the second plate being approximately the same as the radius of the circular cross-section of the duct and having a co-alignment mechanism registering with the alignment mechanism in the first plate and having holes that register with the rectangular slots at the corners of the first plate;
(c) a gasket which is to be positioned between the first and second plates;
(d) bolts extending through the holes in the second plate and threaded into the captive nuts slideably retained within the first plate; wherein
(e) the nuts and the bolts can be tightened to draw the first and second plates together and to exert a compressive force upon the gasket.

2. The access door of claim 1 wherein the opening is rectangular.

3. The access door of claim 1 wherein the gasket is a non-flammable gasket which can withstand temperatures resulting from burning debris located within a duct.

4. The access door of claim 1 wherein the first and second arcuate rectangular plates are formed of steel and are sufficiently rigid to withstand heat within the duct without warping.

5. The access door of claim 1 wherein the duct rectangular opening overlaps the first and second arcuate plates by at least one inch on all sides of the rectangular opening.

6. The access door of claim 1 wherein each of the two bolts fixed to the first plate is located at the highest point of the convex surface of the first plate.

7. The access door of claim 1 wherein the captive nut assemblies at the corners of the first plate are each located within rectangular slots that are oriented to be parallel to the ends of the first and second plates.

8. The access door of claim 1 wherein the gasket is formed from ceramic fiber board.

9. In an access door allowing access to the interior of a circular cross-section duct with a rectangular opening having first and second coextensive arcuate rectangular plates that are connected by two bolts with a gasket between the first and second rectangular plates wherein the first and second rectangular plates are larger than the circular cross-sections duct rectangular opening and the first arcuate plate is positioned within the duct through the rectangular opening and the gasket and the second arcuate plate is positioned outside the duct rectangular opening and the plates are drawn together by nuts tightened onto the two bolts, the improvement comprising:
(a) forming four captive nut assemblies slideingly received within rectangular slots formed at the corners of the first rectangular plate;
(b) forming four holes in the second arcuate rectangular plate registering with the captive nut assemblies in the first arcuate rectangular plate to receive bolts that are threaded into the captive nut assemblies in the first arcuate rectangular plate;
(c) providing a non-flammable gasket coextensive with at least the perimeters of the first and second rectangular plates and fixed to the second arcuate rectangular plate; and
(d) the bolts being tightened to exert a compressive force on the gasket at the corners of the first and second arcuate rectangular plates.

10. The access door of claim 9 wherein the first and second arcuate rectangular plates are formed of steel and are sufficiently rigid to withstand heat within the duct without warping.

11. The access door of claim 9 wherein each of the two bolts connecting the first and second coextensive arcuate rectangular plates is located at the highest point of the convex surface of the first plate.

12. The access door of claim 9 wherein the gasket is formed from ceramic fiberboard.

13. An access door to allow access to the interior of a circular cross-section duct having an opening formed therein comprising:
(a) an arced rectangular duct opening member larger in each dimension than the duct opening, with the radius of the arced rectangular duct opening member being approximately the same as the radius of the circular cross-section duct;
(b) the arced rectangular duct opening member having complementary sliding fasteners or holes located in the corners of the arced rectangular duct opening member;
(c) a rectangular plate of approximately the same size as the arced rectangular duct opening member with the radius of the arc of the rectangular plate being approximately the same as the radius of the circular cross-section of the duct;
(d) the rectangular plate having complementary sliding fasteners or holes at the corners of the rectangular plate corresponding to the arced rectangular duct opening member complimentary sliding fasteners or holes, the sliding fastener on the arced duct opening member or the rectangular plate registering with the holes on either the arced duct opening member or the rectangular plate.
(e) a gasket fixed to the rectangular plate and positioned between the rectangular arced duct opening member and the rectangular plate; and
(f) a co-fastener that threadably connects with the sliding fastener to create a connection that extends through the holes so that the arced rectangular duct opening member and the rectangular plate are connected in the duct opening so that when the fasteners and co-fasteners are tightened they draw the arced rectangular duct opening member and the rectangular plate together to exert a compressive force upon the gasket and create a sealed connection with the circular duct.

14. The access door as recited in claim 13 wherein the opening is rectangular.

15. The access door as recite in claim 13 wherein the gasket is a non-flammable gasket which can withstand temperatures resulting from burning debris located within a duct.

16. The access door as recited in claim 13 wherein the arced rectangular duct opening member is a frame.

17. The access door as recited in claim 16 wherein the frame is welded within the duct opening.

18. The access door as recited in claim 13 wherein the fastener is a captive nut and the co-fastener is a bolt.

19. The access door as recited in claim 13 wherein the fastener is a bolt and the co-fastener is a captive nut.

20. The access door as recited in claim 13 wherein the arced rectangular duct opening member is a plate.

21. A method for manufacturing an access door to allow access to the interior of a circular duct comprising:
(a) providing a rectangular duct opening member that is flat, the rectangular duct opening member having rectangular slots in the corners;
(b) providing a rectangular plate that is approximately the same size as the rectangular duct opening member and which is flat, the rectangular plate having holes in the corners that register with the slots;
(c) determining a desired radius for a particular circular duct;
(d) forming the rectangular plate to the desired radius;
(e) forming the rectangular duct opening member to the desired radius;
(f) providing slideable fastener mechanisms to be used to connect the rectangular duct opening member to the rectangular plate, the slideable fastener having a sealing plate, a nut and bolt wherein either the nut or the bolt is slideable within the slots and the sealing plate is used to cover remaining space in the slots.

22. The method as recited in claim 21 including providing a non-flammable gasket which can withstand temperatures resulting from burning debris located within a duct, the gasket fixed to the rectangular plate.

23. A method for manufacturing an access door to allow access to the interior of a circular duct comprising:
(a) providing a rectangular duct opening member that is flat, the rectangular duct opening member having rectangular holes in the corners;
(b) providing a rectangular plate that is approximately the same size as the rectangular duct opening member and which is flat, the rectangular plate having slots in the corners that register with the holes;
(c) determining a desired radius for a particular circular duct;
(d) forming the rectangular plate to the desired radius;
(e) forming the rectangular duct opening member to the desired radius;
(f) providing slideable fastener mechanisms to be used to connect the rectangular duct opening member to the rectangular plate, the slideable fastener having a sealing plate, a nut and bolt wherein either the nut or bolt is slideable within the slots and the sealing plate is used to cover remaining space in the slots.

24. The method as recited in claim 23 including providing a non-flammable gasket which can withstand temperatures resulting from burning debris located within a duct, the gasket being fixed to the rectangular plate.

25. A method for installing a sandwich door comprising:
(a) providing a rectangular duct opening member, the rectangular duct opening member having rectangular slots in the corners;
(b) providing a rectangular plate that is approximately the same size as the rectangular duct opening member;
(c) providing a gasket;
(d) providing slideable fastener mechanisms to be used to connect the rectangular duct opening member to the rectangular plate, the slideable fastener having a sealing plate, a nut and bolt wherein either the nut or bolt is slideable within the slots and the sealing plate is used to cover remaining space in the slots; and
(f) installing the rectangular duct opening member within the duct so that a sandwich with the rectangular plate and the gasket is created and in order to obtain a registry between the nuts and the bolts the nuts are slid to align properly with the bolts to create a proper seal.

26. The access door as recited in claim 1 wherein the alignment mechanism and the co-alignment mechanism are bolts and holes.
